(19) United States
(12) Patent Application Publication
(10) Pub. No.: US 2013/0048195 A1
(43) Pub. Date: Feb. 28, 2013

(54) MANUFACTURING METHOD OF LIQUID CRYSTAL PANEL AND PERFORATION DEVICE

(71) Applicants: Kazuya OHASHI, Inagi (JP); Hidenobu HAMADA, Inagi (JP); Junji TOMITA, Inagi (JP)

(72) Inventors: Kazuya OHASHI, Inagi (JP); Hidenobu HAMADA, Inagi (JP); Junji TOMITA, Inagi (JP)

(73) Assignee: FUJITSU FRONTECH LIMITED, Tokyo (JP)

(21) Appl. No.: 13/597,915

(22) Filed: Aug. 29, 2012

(30) Foreign Application Priority Data
Aug. 31, 2011 (JP) 2011-189197

(51) Int. Cl. B32B 37/14; B32B 37/06; B32B 38/04

(52) U.S. Cl. 156/87; 156/510; 156/380.9

(57) ABSTRACT

When a liquid crystal panel in which a liquid crystal is enclosed between two substrates is manufactured, a space is provided as an aperture when the liquid crystal is injected, and a sealant for bonding the two substrates is applied to one of the two substrates along a first path encompassing a first area in which the liquid crystal is enclosed, and a second path encompassing a second area facing the first area with the space interposed between the areas. The two substrates to one of which the sealant is applied are bonded. In the system according to the present invention, only the sealant applied along the second path is hardened first on the bonded two substrates. After hardening the sealant applied along the second path, a hole which is an aperture for forcibly removing a gas generated when the sealant of the first path is hardened is formed.

### CROSS-REFERENCE TO RELATED APPLICATION

This application is based upon and claims the benefit of priority from the prior Japanese Patent Application No. 2011-189197 filed on Aug. 31, 2011, the entire contents of which are incorporated herein by reference.

### FIELD

The present invention relates to the technology of manufacturing a liquid crystal panel obtained by enclosing a liquid crystal between two substrates.

### BACKGROUND

A liquid crystal panel obtained by enclosing a liquid crystal between two substrates has the merit of having a relatively thin and light-weight structure. Therefore, the liquid crystal panel has been widely used as an information display screen of a display device.

Two substrates of a liquid crystal panel are bonded by a sealant. The sealant limits the range of enclosing a liquid crystal between the two substrates. Thus, the liquid crystal is enclosed in the range encompassed by the sealant between the two substrates.

The liquid crystal is injected after fully hardening the sealant. In the stage of bonding the two substrates, the sealant is placed in an unhardened state or a half-hardened state so that the two substrates can be bonded.

The sealant generates a gas when it is hardened. The gas reforms the liquid crystal. The liquid crystal is injected after hardening the sealant. Accordingly, when the sealant is fully hardened, the gas generated from the sealant is forcibly removed.

Not to keep the distance between the two substrates too narrow, it is common to arrange spacers between the two substrates. In addition, when flexible substrates such as films etc. are used, there is a member (structures) for keeping the distance between the two substrates not too wide arranged between the two substrates. The structures are to bond the two substrates like the sealant, and are necessary to perform the hardening process. When the structures are hardened, a gas is generated as with the sealant. When the structures are used, a larger amount of gas is generated, thereby enhancing the probability of the necessity to remove the gas.

A method of removing the gas, decreasing the pressure of a panel, and removing the gas from the space of the sealant through which the liquid crystal is injected is considered. However, since the method requires a heating process using infrared light (infrared ray), there occurs uneven heating when a large number of panels are simultaneously processed. Therefore, the method is not appropriate. In addition, although there is a method of absorbing the gas from the space in the sealant, it is hard to use the method because the gas cannot be appropriately absorbed from the uneven surface of the panel which may have broken portions in the surface.

A method of forcibly removing the gas can be, for example, absorbing the gas from the hole which is made as an aperture in the two substrates respectively. The hole can be made in the two substrates because the substrate having a flat surface can contact the member for absorbing the gas in an appropriate state.

The hole through which the gas is absorbed is made outside the area in which a liquid crystal is enclosed (hereafter referred to as an “enclosed area”) so that the entire area can be used as a display area. To absorb the gas through the hole made outside the area, the sealant is applied to form a path (first path) for enclosing the enclosure area by providing a space for injecting a liquid crystal, and a path (second path) for enclosing the area including the aperture facing the enclosure area with the space interposed (FIG. 1G). The area facing the enclosure area is hereafter referred to as a “processing area” because it is predicted that a perforating process is performed.

The sealant before fully hardening is soft and has low adhesive strength. Since it is common that the hole is made using a tool, at least one of the two substrates is subject to a certain level of force when the hole is made. The force may transform the sealant into an inappropriate state. When the sealant enters the inappropriate state, there occurs a problem that, for example, the distance between the two substrates cannot be maintained within an appropriate range. If the structures are arranged, the structures may enter an inappropriate state. Therefore, the processing area has conventionally been kept large so that an undesired influence of the force when raised during the perforating process may be reduced on the sealant enclosing the enclosure area. Hereafter, the inappropriate state of the sealant, the structures, etc. is referred to as “damage”.

The part including the processing area of the substrate and the sealant of the part enclosing the processing area are discarded. Therefore, to reduce the manufacture cost (cost of material) of the liquid crystal panel, it is preferable that the processing area can be smaller. However, if the processing area is smaller, there is a stronger possibility that the sealant encompassing the enclosure area is damaged when the hole is made. The damage of the sealant means an occurrence of a waster during the manufacturing process. A higher probability of the occurrence of the waster increases the manufacture cost. Thus, it is important to reduce the processing area while suppressing the occurrence of the damage of the sealant.

There is a method of making a hole in at least one of the two substrates in advance, to reduce the processing area more efficiently. However, when a perforating process is performed, dust can be made. The dust has to be removed to manufacture a liquid crystal panel because, in the manufacturing process of the liquid crystal panel, as in the process of, for example, generating an electrode on a substrate, the dust can generate a waster at a high probability. Thus, making a hole in advance requires adding the process of removing dust etc. Since adding a process (facility) increases the manufacture cost, it is not preferable to adopt the method of making a hole in advance.

A document of prior art can be, WO2007/102197, Japanese Laid-open Patent Publication No. 2000-155325, and Japanese Laid-open Patent Publication No. 2010-249923.

### SUMMARY

The present invention aims at providing the technology of suppressing the generation of damage of a sealant for bonding two substrates, and reducing the processing area in which a hole is made in the bonded two substrates.

In the system according to the present invention, when a liquid crystal panel is manufactured by enclosing a liquid crystal between two substrates, a sealant for bonding the two substrates is applied on one of the two substrates along a first path encompassing a first area in which the liquid crystal is enclosed, and a second path encompassing a second area facing the first area with a space provided as an aperture when the liquid crystal is injected, the two substrates to one of which the sealant is applied are bonded, only the sealant applied along the second path is hardened first, and then a hole which is an aperture for forcibly removing a gas generated when the sealant of the first path is hardened is formed.

### BRIEF DESCRIPTION OF DRAWINGS

FIG. 1A is an explanatory view of the manufacturing process of a liquid crystal panel which a manufacturing method of a liquid crystal panel according to an embodiment of the present invention can be adopted (patterning);

FIG. 1B is an explanatory view of the manufacturing process of a liquid crystal panel which a manufacturing method of a liquid crystal panel according to an embodiment of the present invention can be adopted (forming an alignment layer);

FIG. 1C is an explanatory view of the manufacturing process of a liquid crystal panel which a manufacturing method of a liquid crystal panel according to an embodiment of the present invention can be adopted (forming structures);

FIG. 1D is an explanatory view of the manufacturing process of a liquid crystal panel which a manufacturing method of a liquid crystal panel according to an embodiment of the present invention can be adopted (applying a sealant, splaying spacers);

FIG. 1E is an explanatory view of the manufacturing process of a liquid crystal panel which a manufacturing method of a liquid crystal panel according to an embodiment of the present invention can be adopted (bonding, provisional hardening);

FIG. 1F is an explanatory view of the manufacturing process of a liquid crystal panel which a manufacturing method of a liquid crystal panel according to an embodiment of the present invention can be adopted (first cutting);

FIG. 1G is an explanatory view of the manufacturing process of a liquid crystal panel which a manufacturing method of a liquid crystal panel according to an embodiment of the present invention can be adopted (second cutting, perforating);

FIG. 1H is an explanatory view of the manufacturing process of a liquid crystal panel which a manufacturing method of a liquid crystal panel according to an embodiment of the present invention can be adopted (heating (full hardening);

FIG. 1I is an explanatory view of the manufacturing process of a liquid crystal panel which a manufacturing method of a liquid crystal panel according to an embodiment of the present invention can be adopted (cutting contour);

FIG. 1J is an explanatory view of the manufacturing process of a liquid crystal panel which a manufacturing method of a liquid crystal panel according to an embodiment of the present invention can be adopted (injecting liquid crystal);

FIG. 1K is an explanatory view of the manufacturing process of a liquid crystal panel which a manufacturing method of a liquid crystal panel according to an embodiment of the present invention can be adopted (enclosing);

FIG. 2 is an explanatory view of the method of removing gas generated when a sealant is fully hardened;

FIG. 3 is an explanatory view of the appearance of a perforation device according to an embodiment of the present invention;

FIG. 4A is an explanatory view of the usage of a perforation device according to an embodiment of the present invention (positioning);

FIG. 4B is an explanatory view of the usage of a perforation device according to an embodiment of the present invention (perforating process);

FIG. 5 is an explanatory view of the circuit configuration of a perforation device according to an embodiment of the present invention;

FIG. 6A is an explanatory view of the portion discarded by the width of the processing area of a bonded film (when the area is narrow);

FIG. 6B is an explanatory view of the portion discarded by the width of the processing area of a bonded film (when the area is wide);

FIG. 7A is an explanatory view (1) of the perforating process performed by a variation example of the perforation device according to an embodiment of the present invention;

FIG. 7B is an explanatory view (2) of the perforating process performed by a variation example of the perforation device according to an embodiment of the present invention;

FIG. 7C is an explanatory view (3) of the perforating process performed by a variation example of the perforation device according to an embodiment of the present invention;

FIG. 7D is an explanatory view (4) of the perforating process performed by a variation example of the perforation device according to an embodiment of the present invention;

FIG. 8A is an explanatory view (1) of the perforating process performed by another variation example of the perforation device according to an embodiment of the present invention;

FIG. 8B is an explanatory view (2) of the perforating process performed by another variation example of the perforation device according to an embodiment of the present invention; and

FIG. 8C is an explanatory view (3) of the perforating process performed by another variation example of the perforation device according to an embodiment of the present invention.

### DESCRIPTION OF EMBODIMENTS

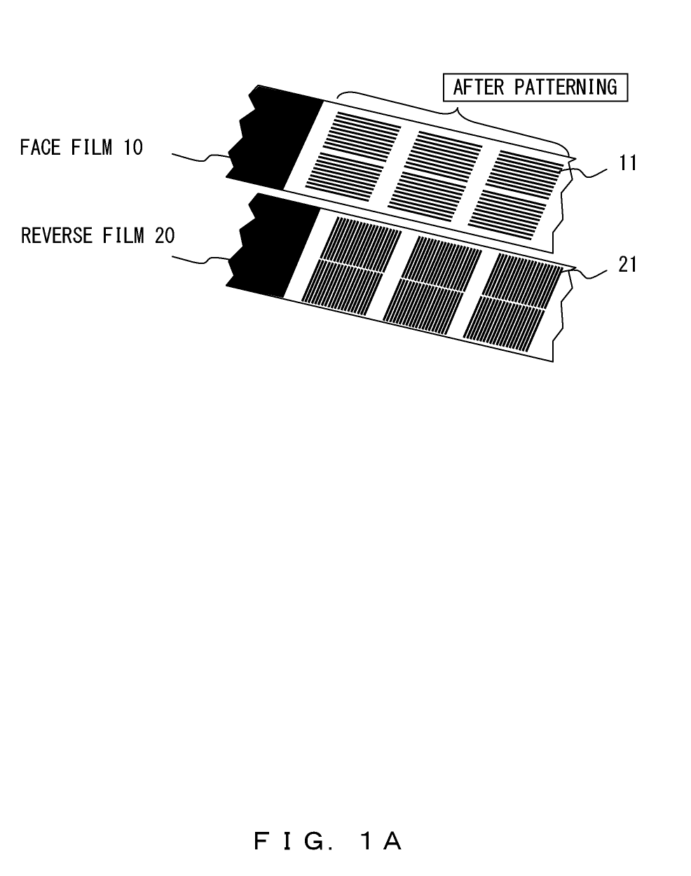

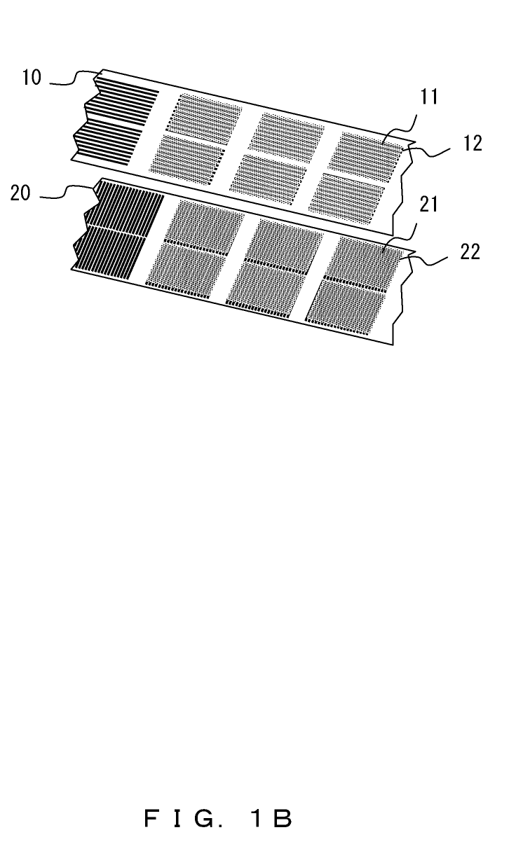

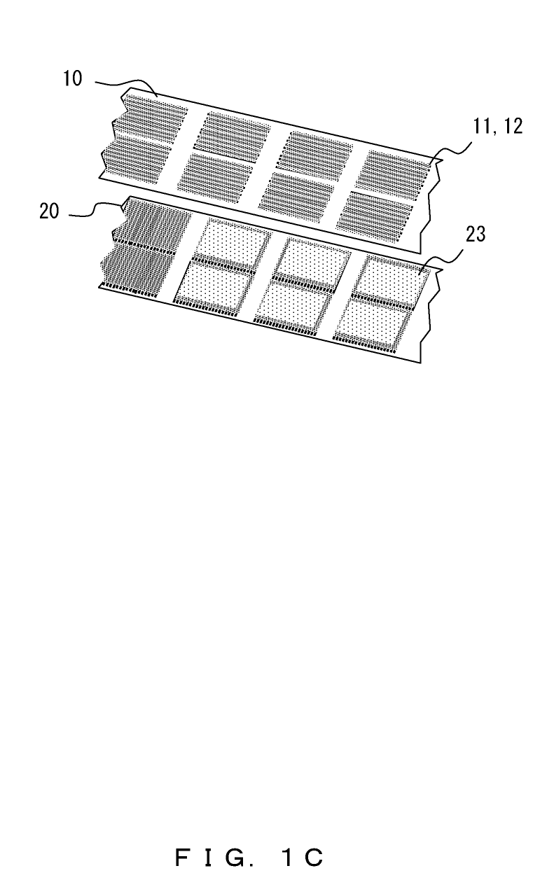

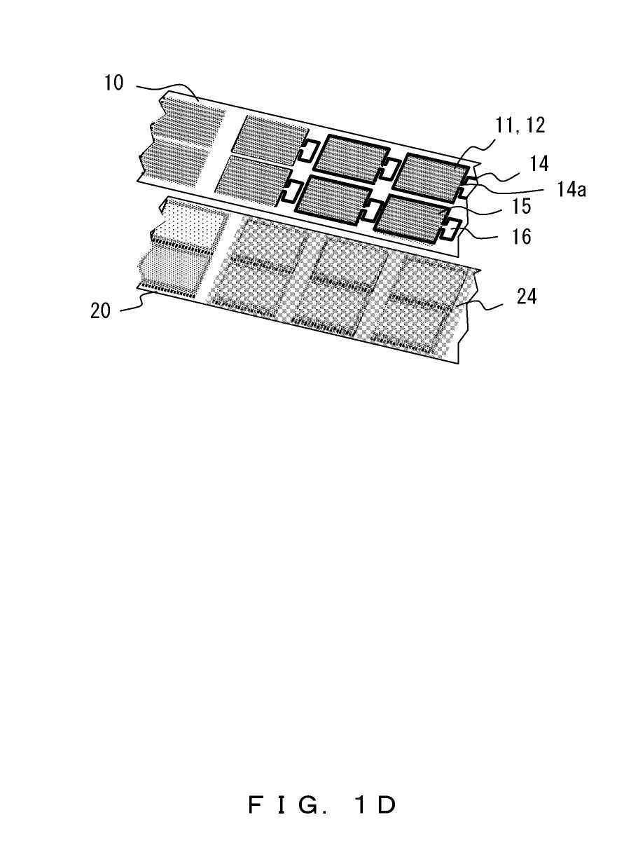

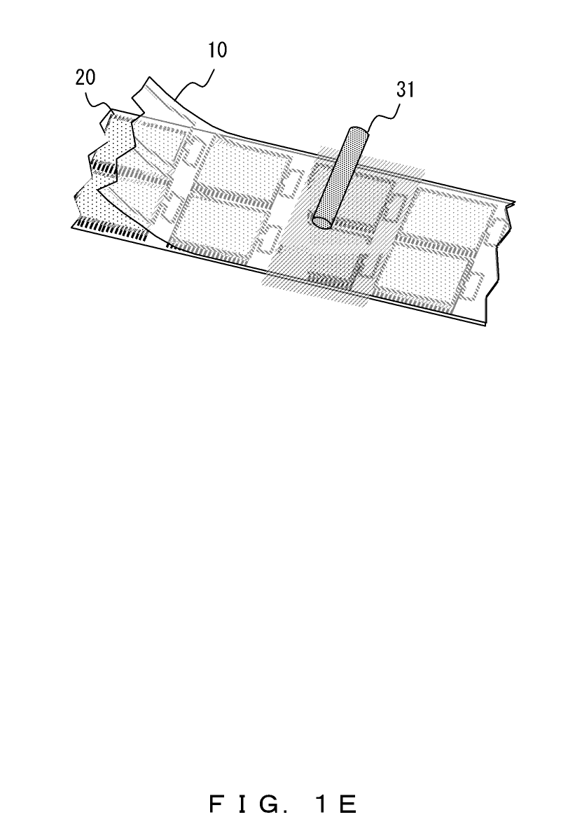

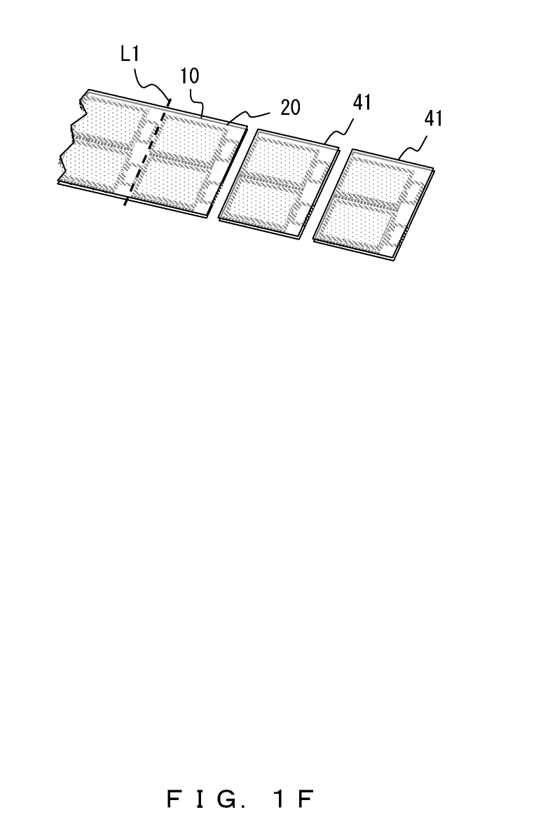

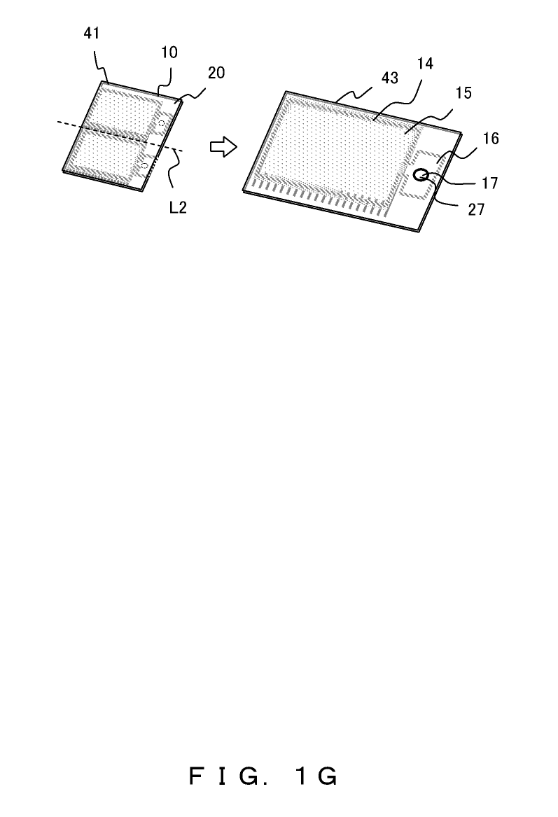

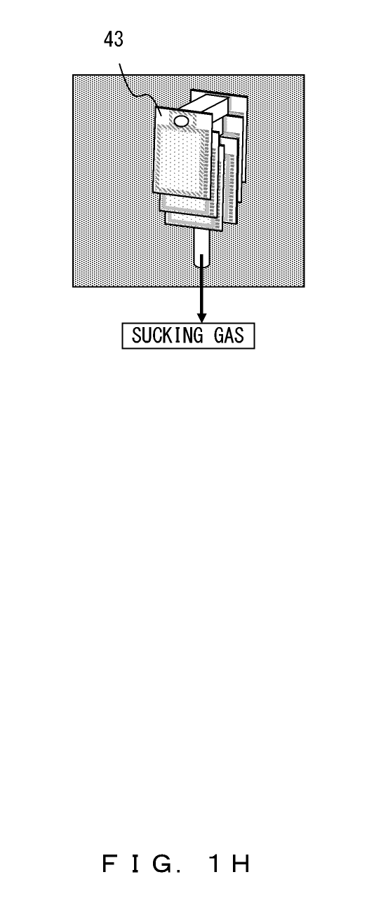

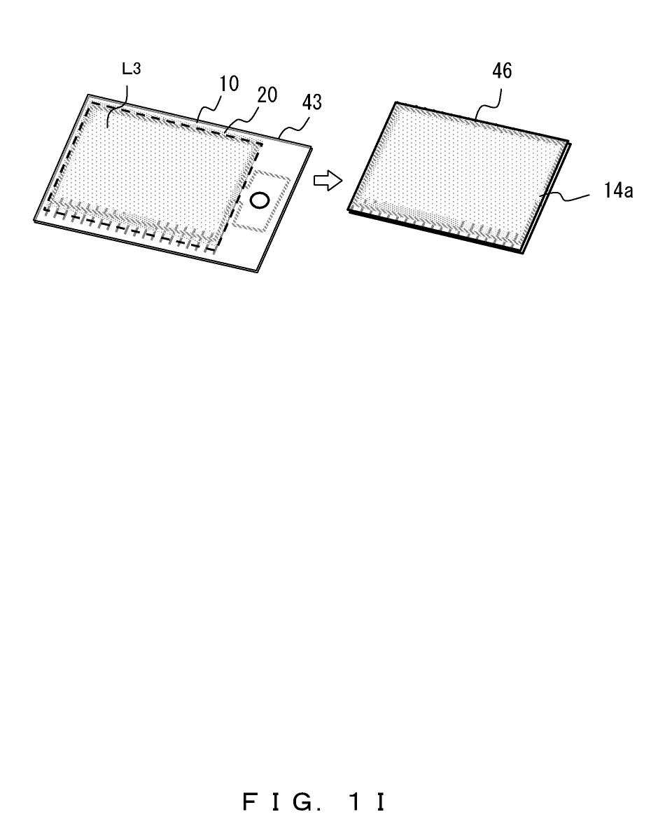

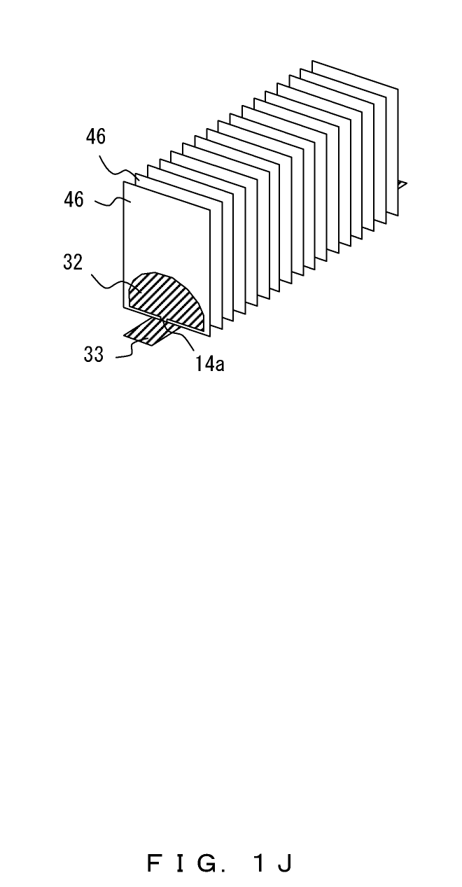

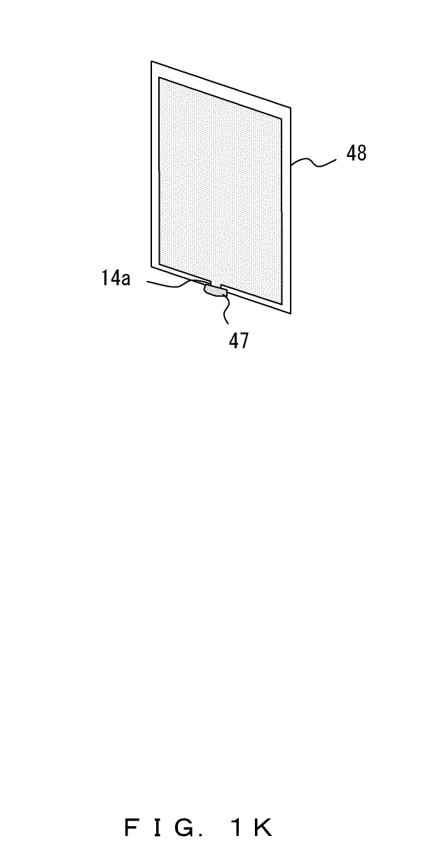

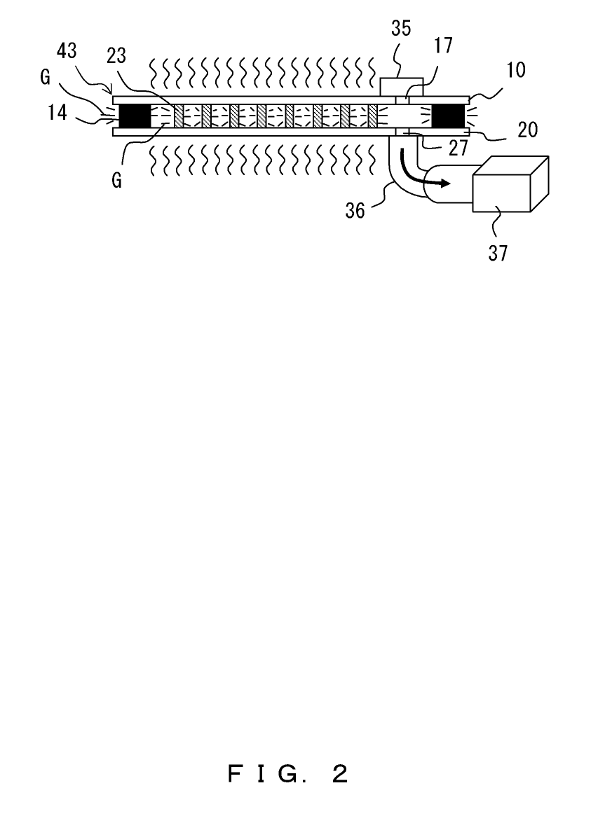

First, the manufacturing process of a liquid crystal panel that disclosed the manufacturing method of the liquid crystal panel and the perforation device according to the embodiment is applicable is described below with reference to FIGS. 1A through 1K and FIG. 2.

FIGS. 1A through 1K are explanatory views of the manufacturing process of the liquid crystal panel which a manufacturing method of a liquid crystal panel according to the present embodiment can be adopted.

FIGS. 1A through 1K exemplifies the manufacturing process performed when a transparent film is used as two substrates. Using the film, a liquid crystal panel is to be manufactured by cutting the film. By considering an example using the film, the manufacturing process illustrated in FIGS. 1A through 1K can be transformed. Thus, the manufacturing process of the liquid crystal panel in the manufacturing method of the liquid crystal panel according to the embodiment of the present invention is not limited to the processes illustrated in FIGS. 1A through 1K.

As illustrated in FIG. 1A, on one side of each of a face side film (hereafter referred to as a “face film”) 10, and a reverse side film (hereafter referred to as a “reverse film”) 20, a patterning process in which electrodes 11 and 21 are formed is performed. The electrode 11 formed on the face film 10 is, for example, a pixel electrode, and the electrode 21 formed on the reverse film 20 is, for example, a common electrode. The face side refers to the naming based on the direction in which the liquid crystal panel is viewed when the liquid crystal panel displays information, and the position in which the panel is viewed is the front side.

After performing the patterning process, as illustrated in FIG. 1B, alignment layers 12 and 22 are formed on the surface on which the electrodes 11 and 21 of each of the films 10 and 20 are formed. The alignment layers 12 and 22 are formed to cover the entire electrodes 11 and 21 because the range in which the electrodes 11 and 21 are formed can be a display area.

Structures 23 for protection against a large space between the films 10 and 20 are formed on the alignment layer 22 of the reverse film 20 as illustrated in FIG. 1C. In FIG. 1C, the structures 23 are drawn by small dots.

After forming the structures 23, as illustrated in FIG. 1D, a sealant 14 is applied as enclosing the electrode 11 and the alignment layer 12. On the side on which the electrode 21 is formed of the reverse film 20, a spacer 24 is arranged by a spraying operation.

The sealant 14 is applied along the path (first path) enclosing an area 15 on which the electrode 11 and the alignment layer 12 of the face film 10 are formed with a space 14a. In addition, the sealant 14 is applied along the path (second path) enclosing another area 16 facing the area 15 from the space 14a. The space 14a is an injection inlet of the liquid crystal. Since the area 15 is a portion in which the liquid crystal is enclosed, it is hereafter referred to as an “enclosure area”. Since the area 16 is a portion in which a hole is made, it is hereafter referred to as a “processing area”.

The sealant 14 is hardened by the irradiation of ultraviolet rays or heating. The sealant 14 applied to the face film 10 is half-hardened (provisionally hardened) after bonding the films 10 and 20 so that the electrodes 11 and 21 face each other as illustrated in FIG. 1E, and then irradiating ultraviolet rays by a UV lamp 31.

The bonded two films 10 and 20 are cut along the broken line L1 as illustrated in FIG. 1F, thereby producing a bonded film 41 for two liquid crystal panels (first cutting). The bonded film 41 is further cut along the broken line L2 as illustrated in FIG. 1G, thereby separating the film into two bonded films 43 (second cutting). The bonded film 43 is used for one liquid crystal panel. On the bonded film 43 produced as described above, the process of making holes 17 and 27 in the films 10 and 20 in the processing area 16 is performed.

A heating process for fully hardening the sealant 14 is performed as illustrated in FIG. 1H on the bonded film 43 for which the perforating process has been performed.

By the heating process, the sealant 14 and the structures 23 generate a gas. Therefore, when the heating process is performed, a vacuuming process is performed as illustrated in FIG. 2 for forcibly ejecting the gas including a gas G generated in the bonded film 43. To execute the vacuumng process, one of the holes 17 and 27 is blocked by a cover 35, and a pipe 36 is attached to the other hole. A pump 37 sucks the gas in the bonded film 43 through the pipe 36, and discharges the gas. FIG. 1H illustrates an example of the state in which a plurality of bonded films 43 are set to actually perform the vacuuming process.

The bonded film 43 for which the sealant 14 etc. is fully hardened by the heating process is cut to remove a residual portion along the broken line L3. The liquid crystal is injected to a bonded film 46 which is the bonded film 43 after contour cutting process is performed.

As illustrated in FIG. 1J, a liquid crystal 32 is injected by inserting the space 14a of the bonded film 46 in the state in which, for example, the internal pressure is sufficiently reduced into a liquid crystal cell 33 containing the liquid crystal 32. By inserting the space 14a in the state in which the internal pressure is sufficiently reduced into the liquid crystal cell 33, the liquid crystal 32 can be appropriately injected to the entire enclosure area 15. Thus, after injecting the liquid crystal 32, as illustrated in FIG. 1K, a space 14b is blocked by a sealant 47. With the enclosure for the bonded film 46, a liquid crystal panel 48 can be completed.

After fully hardening the sealant 14, as illustrated in FIG. 1I, the cutting operation can be appropriately performed near the sealant 14. However, in the steps of the perforating process before fully hardening the sealant 14, the sealant 14 is in the unhardened state or in the half-hardened state. Therefore, the sealant 14 is easily damaged by the pressure applied during the perforating process. Hence, the perforating process has been conventionally performed relatively apart from the enclosure area 15 to avoid the damage of the sealant 14 enclosing the enclosure area 15. Thus, a large processing area 16 has been reserved. As a result, the width of the processing area 16 in the direction of the array of the enclosure area 15 and the processing area 16 with the space 14a interposed between them.

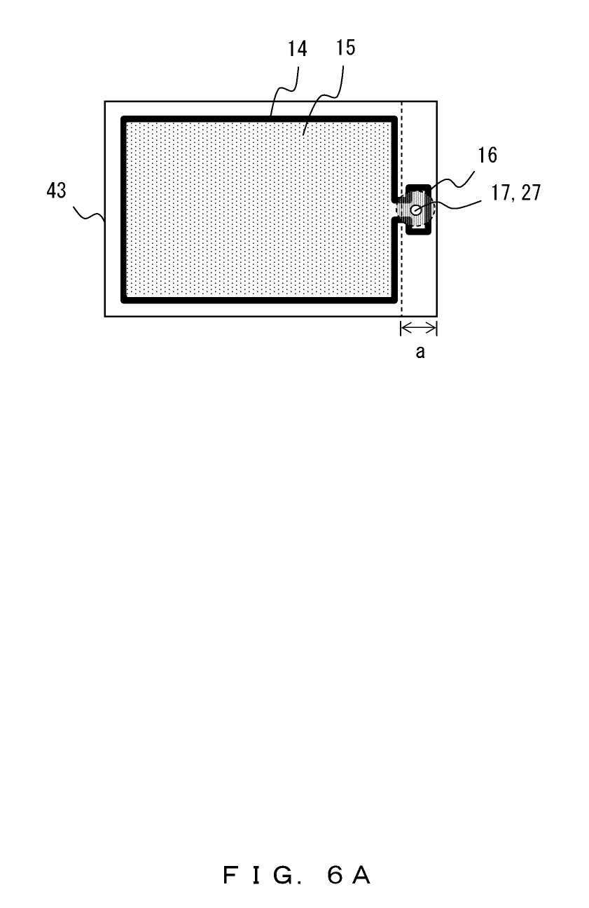

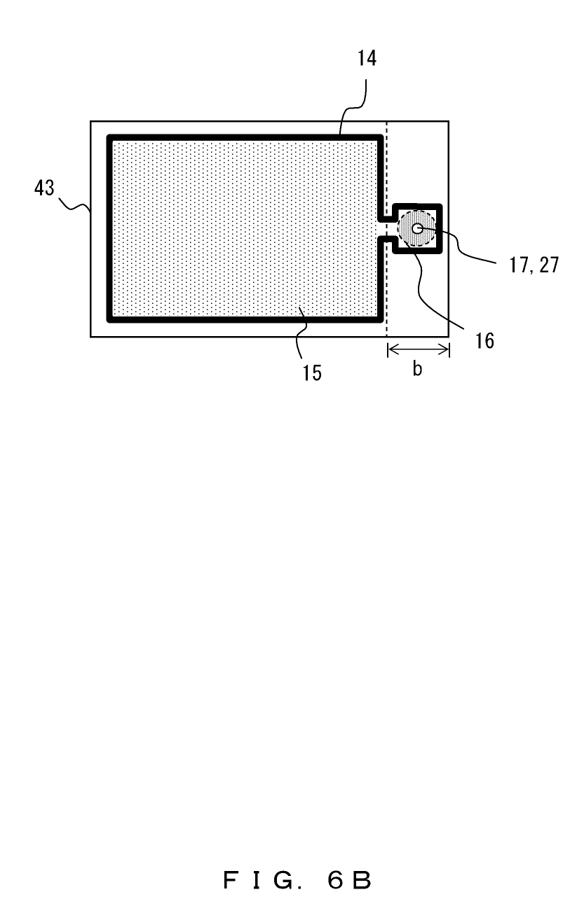

FIGS. 6A and 6B are explanatory views of the portions to be discarded based on the width of the processing area of the bonded film. FIG. 6A illustrates the portion discarded when the area is narrow, and FIG. 6B illustrates the portion discarded when the area is wide.

As illustrated in FIGS. 6A and 6B, the size (area) of the discarding portion of the bonded film 43 changes depending on the width of the processing area 16. The wider the processing area 16, the larger the area of the discarding portion. Therefore, to reduce the manufacture cost of the liquid crystal panel 48, that is, to increase the number of liquid crystal panels 48 per unit length (area) of each of the films 10 and 20, it is necessary to reduce the width of the processing area 16.

Conventionally, a wide processing area 16 is assigned to suppress the damage of the sealant 14 etc. On the other hand, the present embodiment can reduce the width of the processing area 16 while suppressing the damage of the sealant 14 etc. Although the width of the processing area 16 is reduced from the width b as illustrated in FIG. 6B to the width a as illustrated in FIG. 6A, the damage of the sealant 14 etc. can be suppressed. By assigning a narrower processing area 16, a lower manufacture cost of the liquid crystal panel 48 can be realized. The manufacturing method and the perforation device of a liquid crystal panel according to the present embodiment are described below in detail with reference to the attached drawings.

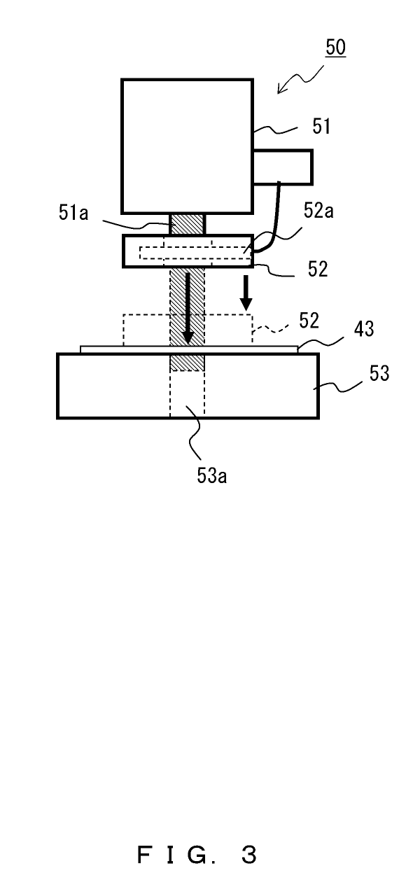

FIG. 3 is an explanatory view of the appearance of a perforation device according to the present embodiment. The perforation device 50 performs a perforating process in which a hole is made in the processing area 16 in the steps of the perforating process on the bonded film 43 illustrated in FIG. 1G. The manufacturing method of the liquid crystal panel according to the present embodiment is realized by performing the perforating process using the perforation device 50 in the processing area 16 of bonded film 43.

As illustrated in FIG. 3, the perforation device 50 is provided with a body 51 of the device, a heating head 52, and a device table 53.

The device table 53 is a table on which the bonded film 43 to be processed in the perforating process is placed. The heating head 52 is to heat the sealant 14 of the processing area 16 of the bonded film 43 placed on the device table 53. A heater 52a is arranged as a heat source in the heating head 52.

The body 51 of the device controls the entire perforation device 50, and is provided with a tool 51a for performing the perforating process. The body 51 of the device performs the perforating process on the bonded film 43 placed on the device table 53 by moving the tool 51a up and down.

The body 51 of the device moves the heating head 52 up and down. When the bonded film 43 is heated, the heating head 52 is moved down to the position indicated by the broken line, that is, for example, to the position where the head 52 contacts the bonded film 43. By the movement, the bonded film 43 can be efficiently heated by the heating head 52.

The perforation device 50 having the above-mentioned components is realized by an operator placing the bonded film 43 on the device table 53 and directing the start of the up and down movement of the tool 51a. The perforation device 50 can also automatically perform at least one of placing the bonded film 43 on the device table 53 and performing the perforating process by the up and down movement of the tool 51a.

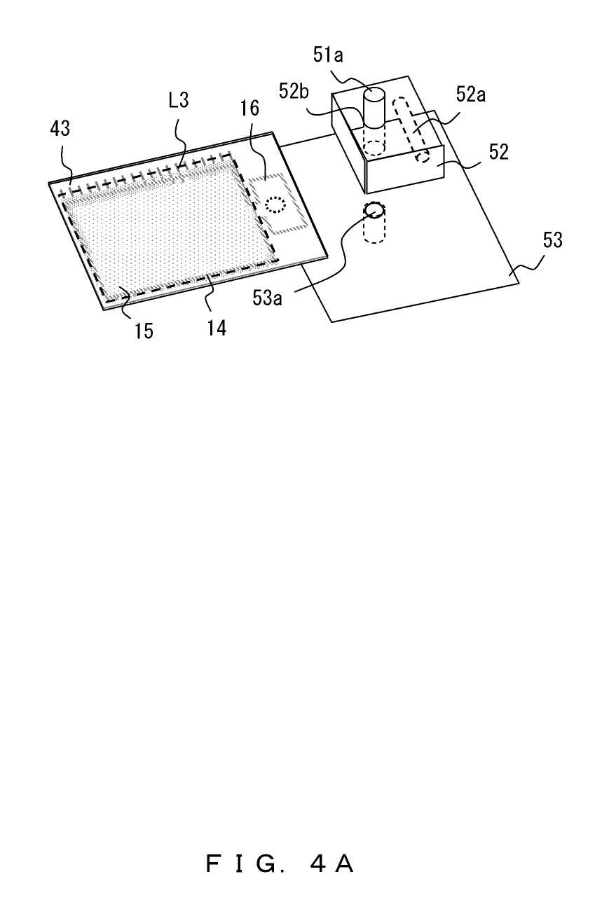

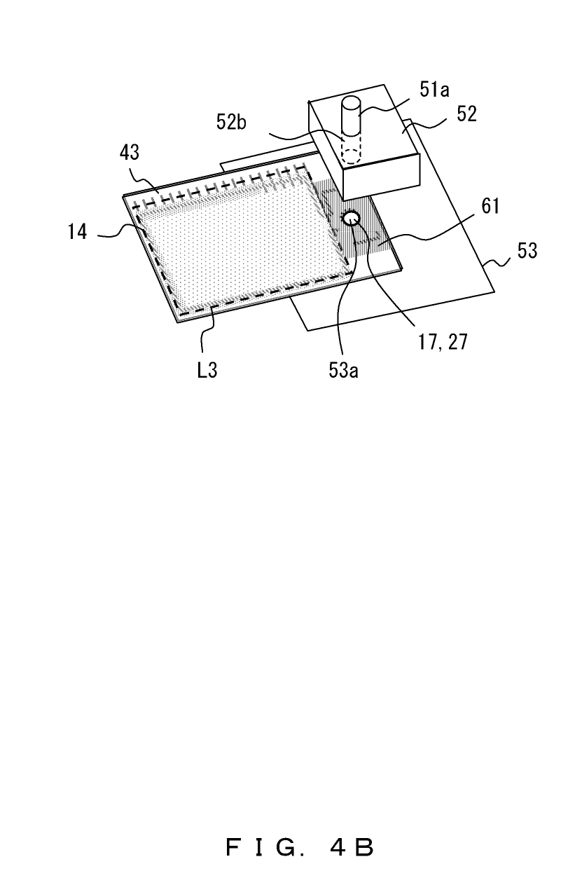

FIGS. 4A and 4B are explanatory views of the method of using the perforation device. FIG. 4A illustrates the method of placing the bonded film 43 on the device table 53, and FIG. 4B illustrates the perforating process performed on the bonded film 43 placed on the device table 53.

As illustrated in FIG. 4A, the device table 53 has a hole 53a into which the end portion of the tool 51a can be inserted. When the tool 51a is moved up and down to the position where the end portion of the tool 51a can enter the hole 53a, the holes 17 and 27 can be made in the processing area 16 of the bonded film 43 placed on the device table 53 as illustrated in FIG. 4B.

A through hole 52b is formed in the heating head 52, and the tool 51a moves up and down through the through hole 52b. The configuration is devised to make the holes 17 and 27 using the tool 51a in the processing area 16 in which the heating head 52 is heated without removing the heating head 52 so that the head 52 cannot touch the tool 51a. Thus, by providing the through hole 52b in the heating head 52, the structure of the perforation device 50 can be simplified.

Although not specifically illustrated in the attached drawings, the device table 53 is provided with a guide for arrangement of the bonded film 43 at an appropriate position. An operator uses the guide to place the bonded film 43 at the appropriate position on the device table 53. Thus, the bonded film 43 placed on the device table 53 enters the state in which the hole 53a is positioned in the processing area 16. The operator then operates the starting switch to direct the up and down movement of the tool 51a.

When the operator operates the starting switch, the heating head 52 is located at the position indicated by the solid line in FIG. 3. The body 51 of the device lowers the heating head 52 by the operation of the starting switch, thereby moving the head 52 to the position indicated by the broken line. As a result, as illustrated in FIG. 4B, a range 61 including the processing area 16 of the bonded film 43 touches the heating head 52 and is heated. The range 61 is hereafter referred to as a “heating range 61”.

The heating operation performed using the heating head 52 is continued until, for example, the sealant 14 in the heating range 61 is fully or substantially fully hardened. When the heating operation is performed, the body 51 of the device lowers the tool 51a without lifting the heating head 52, or lowers the tool 51a while lifting the heating head 52. In this example, for convenience of explanation, it is assumed that the tool 51a is lowered without lifting the heating head 52. It is also assumed that the heating head 52 is lifted while moving the tool 51a up and down. When the heating head 52 is lifted with the timing above, the time taken to move the tool 51a and the heating head 52 can be shorter than in the case in which the tool 51a and the heating head 52 are separately moved.

By the heating operation performed using the heating head 52, the sealant 14 in the heating range 61 of the bonded film 43 is hardened, and the hardened sealant 14 is not easily damaged, thereby successfully standing a higher pressure. Therefore, although the processing area 16 becomes narrower, the sealant 14 is not damaged at the portion enclosing the enclosure area 15 when the perforating process is performed. Although the width of the processing area 16 is changed from the width b as illustrated in FIG. 6B to the width a as illustrated in FIG. 6A, the perforating process can be appropriately performed while avoiding the damage of the sealant 14 at the portion enclosing the enclosure area 15. Therefore, the manufacture cost of the liquid crystal panel 48 manufactured by narrowing the processing area 16 can be reduced more easily.

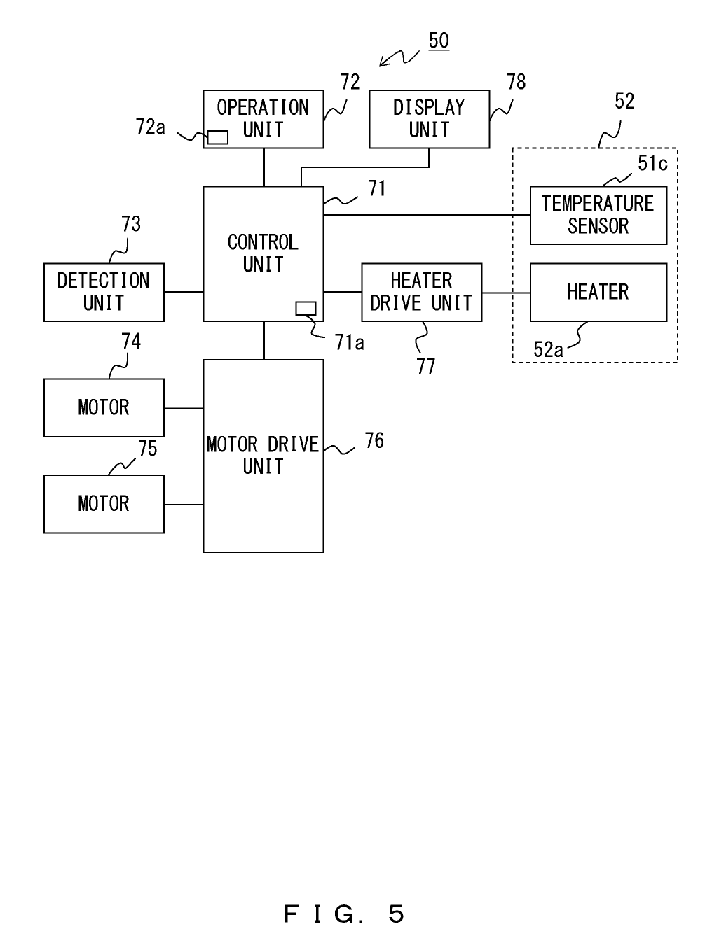

FIG. 5 is an explanatory view of the circuit configuration of the perforation device above. As illustrated in FIG. 5, the perforation device 50 includes the heater 52a, a temperature sensor 51c, a control unit 71, a operation unit 72, a detection unit 73, two motors 74 and 75, a motor drive unit 76, a heater drive unit 77, and a display unit 78. Instead of the motors 74 and 75, a drive system for moving an air cylinder etc. up and down can be used.

The operation unit 72 is used by the operator to direct various settings and operations. The switches provided for the operation unit 72 include a starting switch 72a for directing the start of the perforating process. Settings are made for the temperature of the heating head 52, the heating time of the heating operation by the heating head 52, etc.

The display unit 78 displays necessary information for the operator. The control unit 71 directs the display unit 78 to display the necessary information depending on the operation of the operator on the operation unit 72. Thus, the operator can make various settings while confirming the information displayed on the display unit 78. The control unit 71 stores the set temperature and heating time of the heating head 52 in memory 71a as process information for the perforating process, and reflects the information in executing the perforating process.

The detection unit 73 detects the bonded film 43 appropriately placed on the device table 53. The detection is performed mechanically or optically, and the detection signal indicating the detection result is output to the control unit 71. The mechanical detection can be performed by arranging one or more switches pressed when the bonded film 43 is appropriately placed on the device table 53. The optical detection can be performed by arranging one or more optical sensors whose amount of photoreception changes when the bonded film 43 is appropriately placed on the device table 53. The detecting method is not limited to the applications above, but other method can also be used.

According to the detection signal input from the detection unit 73, the control unit 71 confirms whether or not the bonded film 43 is appropriately placed on the device table 53 when the starting switch 72a is operated. Thus, the control unit 71 enables the operation on the starting switch 72a only when it is confirmed that the bonded film 43 is appropriately placed on the device table 53.

The motor 74 is a power source for moving the tool 51a up and down, and the motor 75 is a power source for moving the heating head 52 up and down. The motor drive unit 76 is a drive circuit for driving motors 74 and 75 at the instruction from the control unit 71.

The motor drive unit 76 rotates the motor 74 in the same direction for a specified number of rotations upon receipt of the instruction to rotate the motor 74 from the control unit 71. By the number of rotations, the tool 51a moves up and down once, and returns to the position in which it was placed before starting the up and down movement.

On the other hand, when the motor 75 is rotated, the control unit 71 issues an instruction to the motor drive unit 76 including the rotation direction. Through the instruction of the rotation direction, the control unit 71 moves up or down the heating head 52.

Depending on the number of rotations of the motor 75, the amount of movement of the heating head 52 can be adjusted. However, when the heating head 52 is heated with the heating head 52 touching the bonded film 43 or moving the heating head 52 to the vicinity of the bonded film 43, it is necessary to control with high accuracy the amount of movement (down movement) to prevent the heating head 52 from adding the pressure that damages the sealant 14 to the bonded film 43.

Thus, it is necessary to detect the distance between the bonded film 43 and the heating head 52 and control the movement of the heating head 52, or to prepare a system for reducing the pressure of the heating head 52 which has contacted the bonded film 43 to be added to the bonded film 43. In the present embodiment, when the level of the resistance occurring when the heating head 52 is moved equals or exceeds a specified level, a system of interrupting the power transmitted from the motor 75 (for example, a clutch) is prepared, thereby preventing the heating head 52 from applying the pressure that damages the sealant 14 of the bonded film 43.

The control unit 71 recognizes the temperature of the heating head 52 according to the signal from the temperature sensor 51c, and reflects the recognition result on the control of the heater drive unit 77. Thus, the control unit 71 controls the temperature of the heater 52a by driving the heater drive unit 77 so that the temperature of the heating head 52 can match the set temperature. Therefore, by controlling the temperature of the heating head 52, the heating of the bonded film 43 by the heating head 52 can be performed according to the constantly set temperature.

When the operator operates the starting switch 72a, the control unit 71 starts the perforating process on condition that the detection signal from the detection unit 73 indicates the appropriate location of the bonded film 43. The perforating process is performed by the flow of control as follows.

The control unit 71 instructs the motor drive unit 76 to drive the motor 75 before moving the tool 51a up and down, and moves the heating head 52 until it contacts the bonded film 43, and then stops the head 52. Thus, the sealant 14 in the heating range 61 is heated, and is further hardened. Afterwards, the control unit 71 instructs the motor drive unit 76 to drive the motor 74 to moves the tool 51a up and down once to make the holes 17 and 27 in the heating range 61. The control unit 71 instructs the motor drive unit 76 to drive the motor 75 while moving the tool 51a up and down, and lifts the heating head 52. Thus, the drive of the motor 74 or 75 is terminated, thereby terminating the control for performing the perforating process.

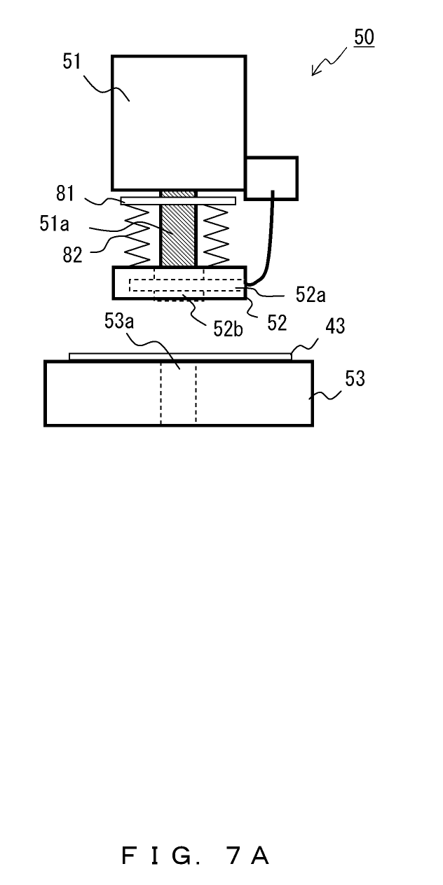

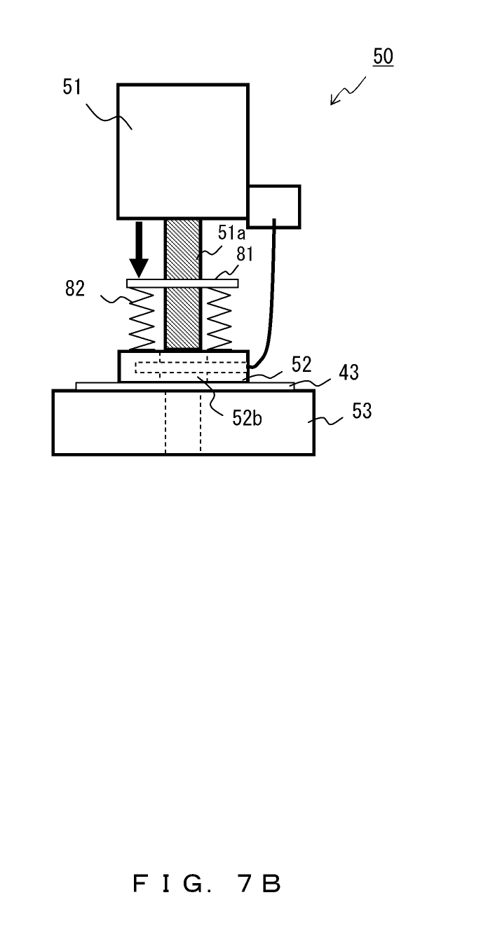

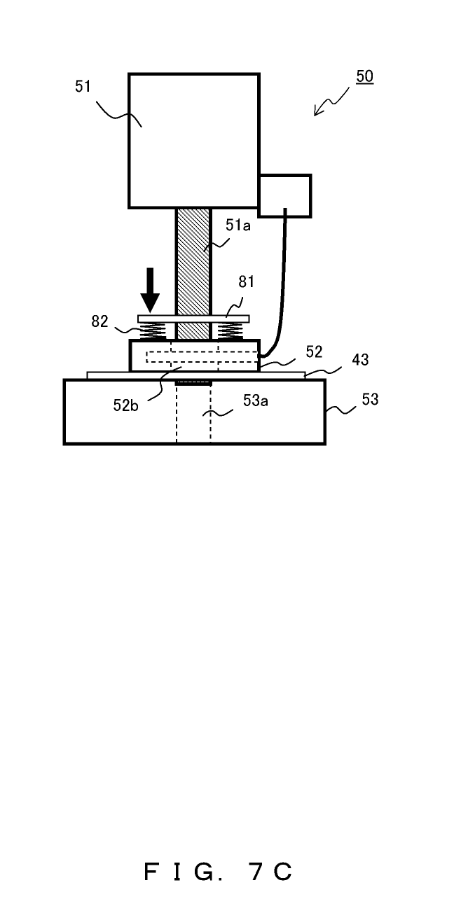

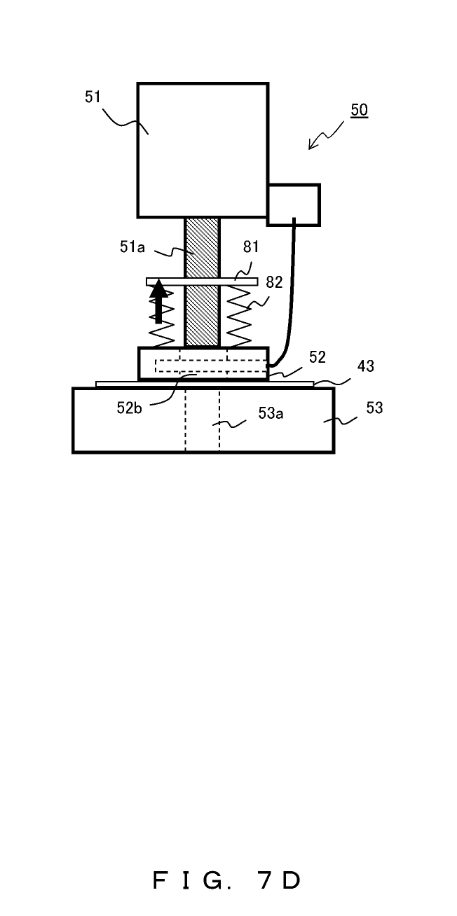

The perforation device according to the present embodiment is provided with two motors 74 and 75 for separately moving up and down the tool 51a and the heating head 52, but one motor can perform the up and down movement. Next, a variation example of the perforation device for moving up and down the tool 51a and the heating head 52 using one motor is practically described below with reference to FIGS. 7A through 7D. In this example, only the different points are explained.

In this variation example, a plate member 81 is attached to the tool 51a as illustrated in FIG. 7A. One end of a spring 82 which enables the tool 51a into the inside of the through hole 52b of the heating head 52 is attached to the plate member 81, and the other end of the spring 82 is attached to the heating head 52. Thus, the heating head 52 is provided in a suspended state for the tool 51a through the plate member 81 and the spring 82. The end portion of the tool 51a is inserted into the through hole 52b of the heating head 52 in the state in which it does not protrude from the through hole 52b.

Thus, by attaching the heating head 52 to the tool 51a, the heating head 52 moves up and down with the up and down movement of the tool 51a. Therefore, in this variation example, the motor 75 is not required, thereby further reducing the manufacture cost.

FIG. 7A illustrates the initial positions of the tool 51a and the heating head 52, that is, the positions immediately before starting the perforating process, and FIGS. 7B through 7D illustrate the change of the positions of the tool 51a and the heating head 52 with the proceeding of the perforating process. The operation when the perforating process of the variation example is performed is described below with reference to FIGS. 7B through 7D.

When the perforating process is performed, the heating head 52 heats the range 61 including the processing area 16 of the bonded film 43. The heating operation is performed by lowering the tool 51a until the heating head 52 contacts the bonded film 43 as illustrated in FIG. 7B. The lowering operation is performed in the range in which the end portion of the tool 51a does not contact the bonded film 43.

As illustrated in FIG. 7C, after the heating operation, the tool 51a is further lowered, and the end portion of the tool 51a reaches the hole 53a of the device table 53. Thus, the holes 17 and 27 are made in the processing area 16 of the bonded film 43. In this case, since the heating head 52 is attached the tool 51a through the spring 82, its position is not changed when the tool 51a is lowered. The tool 51a and the heating head 52 returns to the initial positions as illustrated in FIG. 7D when the tool 51a is lifted afterward.

Thus, the control unit 71 in the variation example as illustrated in FIG. 5 allows the motor drive unit 76 to drive the motor 74 in two stages by the operation of the starting switch 72a, and rotate the motor for the specified number of rotations in the same direction respectively. By the drive in two stages, the tool 51a and the heating head 52 are moved up and down as illustrated in FIGS. 7A through 7D while setting the heating period in which the heating head 52 heats the bonded film 43.

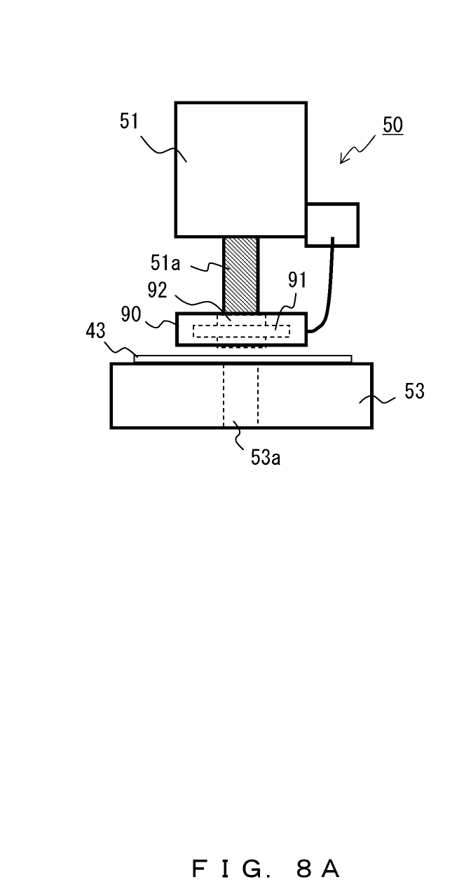

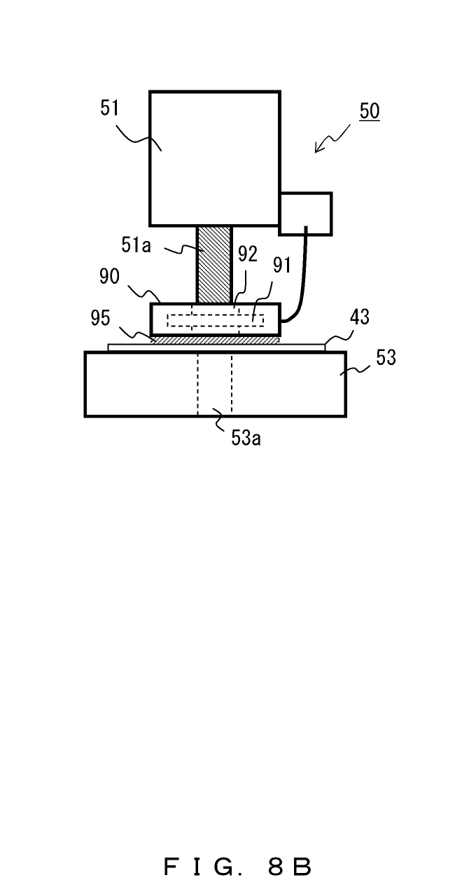

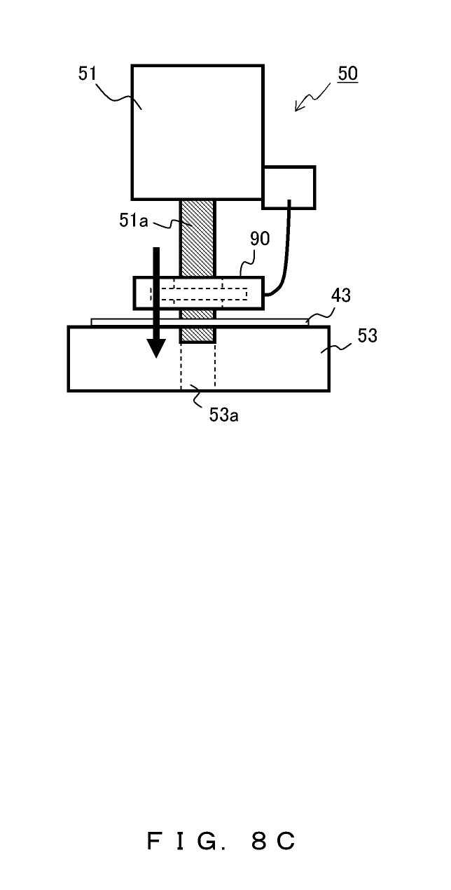

FIGS. 8A through 8C are explanatory views of the perforating process performed by another variation example of the perforation device. The configuration of another variation example and the operation of performing the perforating process according to another variation example are practically described below. The description is made only on the points different from those described above.

In another variation example, as illustrated in FIG. 8A, a heating head 90 provided with an infrared light (infrared ray) lamp 91 is used. Since it is necessary to heat the range including the processing area 16 of the bonded film 43, the heating head 90 irradiates infrared light 95 from the position at a certain distance from the bonded film 43 on the device table 53 as illustrated in FIG. 8B. Thus, since there is a certain distance between the head 90 and the bonded film 43 on the device table 53, the position of the heating head 90 is fixed. Therefore, in another variation example, as with the variation example above, the motor 75 is not required, thereby further reducing the manufacture cost.

The heating head 90 is provided with a through hole 92 for the up and down movement of the tool 51a. The initial position of the tool 51a, that is, the position immediately before starting the perforating process, is the position in which the end portion of the tool 51a enters the through hole 92 of the heating head 90.

When the perforating process is performed, the infrared light 95 is irradiated from the infrared light lamp 91 to the bonded film 43, and the range 61 including the processing area 16 of the bonded film 43 is heated. After the heating operation, the tool 51a is once moved up and down, and the end portion of the tool 51a reaches the hole 53a of the device table 53, thereby making the holes 17 and 27 in the processing area 16 of the bonded film 43. FIG. 8C illustrates the state in which the tool 51a is lowered until its end portion enters the hole 53a. After the up and down movement, the tool 51a is returned to the initial position illustrated in FIG. 8A.

In another variation example, as illustrated in FIG. 5, a lamp drive unit for turning on the infrared light lamp 91 is provided in place of the heater drive unit 77. The control unit 71 allows, for example, a lamp drive unit to light the infrared light lamp 91 for a set time by the operation of the starting switch 72a. Afterwards, the control unit 71 allows the motor drive unit 76 to drive the motor 74. Thus, in another variation example, after the sealant 14 in the processing area 16 is hardened by the heating process using the heating head 90, the perforating process is performed using the tool 51a.

The two variation examples of the perforation devices according to the present embodiment are described above with reference to FIGS. 7A through 8C, and the perforation device realized according to the present embodiment is not limited to these examples. For example, when the sealant 14 that hardening is performed by the method except the heating is adopted, it is necessary to provide a perforation device with a device for hardening the sealant 14. Under the conditions, the perforation device according to the present embodiment is realized in a number of variations. According to the present embodiment, the perforating process is performed on the bonded film 43 for one liquid crystal panel 48, but the perforating process can be performed on the bonded film 41. The perforating process can also be performed after bonding the films 10 and 20. Thus, the perforating process can be performed with preferable timing for a user.

Furthermore, according to the present embodiment, the sealant 14 can be applied as illustrated in FIG. 4A. However, if the enclosure area 15 and the processing area 16 are formed as facing each other with the space 14a interposed between them, the sealant 14 can be applied in a method different from the application illustrated in FIG. 4A. That is, the sealant 14 can be applied so that a closed space including the enclosure area 15 can be formed by the sealant 14 in the bonded film 43, and the gas in the enclosure area 15 can be sucked from outside of the enclosure area 15 of the closed space through the space 14a. Thus, the path of the application of the sealant 14 is not limited to the path illustrated in FIG. 4A.

1. A manufacturing method of a liquid crystal panel in which a liquid crystal is enclosed between two substrates, comprising:
providing a space as an aperture when the liquid crystal is injected, and applying a sealant for bonding the two substrates to one of the two substrates along a first path encompassing a first area in which the liquid crystal is enclosed, and a second path encompassing a second area facing the first area with the space interposed between the areas;
bonding the two substrates to one of which the sealant is applied;
hardening only the sealant applied along the second path on the bonded two substrates;
forming a hole which is an aperture for forcibly removing a gas generated when the sealant of the first path is hardened, after the hardening the sealant of the second path.

2. A perforation device used in manufacturing a liquid crystal panel in which a liquid crystal is enclosed between two substrates, the perforation device comprising:
a hardening unit that hardens a sealant along a second path on the two substrates bonded by the sealant applied along a first path encompassing a first area in which the liquid crystal is enclosed, and the second path encompassing a second area facing the first area with the space interposed between the areas; and
a perforation unit that forms a hole which is an aperture for forcibly removing a gas generated when the sealant of the first path is hardened.

3. The perforation device according to claim 2, wherein
the hardening unit moves a hardening head for hardening the sealant toward the two substrates, thereby hardening the sealant.

4. The perforation device according to claim 3, wherein;
the hardening head is provided with a through hole;
the perforation unit makes the hole in the second area of the two substrates by moving a tool for making the hole toward the two substrates through the through hole provided for the hardening head.

5. The device according to claim 2, wherein
the hardening head is provided with an infrared light irradiator to harden the sealant without contacting the two substrates.
